(19) United States
(12) Patent Application Publication
(10) Pub. No.: US 2024/0014676 A1
(43) Pub. Date: Jan. 11, 2024

(54) DEVICE FOR INERTING A BATTERY AND ASSOCIATED POWER SUPPLY, INERTING METHOD AND SYSTEM

(71) Applicant: SAFT, LEVALLOIS PERRET (FR)

(72) Inventors: Eric PASQUIER, SAINT BENOIT (FR); Hélène TRICOT, VALENCE EN POITOU (FR); Damien ROCHARD, SEVRES-ANXAUMONT (FR)

(73) Assignee: SAFT, LEVALLOIS PERRET (FR)

(21) Appl. No.: 18/038,486

(22) PCT Filed: Nov. 26, 2021
(86) PCT No.: PCT/EP2021/083098

§ 371 Date: May 24, 2023

(30) Foreign Application Priority Data
Nov. 27, 2020 (FR) FR2012259

(51) Int. Cl. H02J 7/00; H02J 7/35; H01M 10/44

(52) U.S. Cl. CPC H02J 7/0069; H02J 7/35; H02J 7/0045; H01M 10/448; H01M 10/0525

(57) ABSTRACT

The present invention relates to a device for inerting a battery comprising a first terminal and a second terminal, the first terminal and the second terminal presenting opposite polarity, the inerting device comprising a connection circuit, the connection circuit connecting the battery to at least one charging circuit, the connection circuit comprising a first connector, a second connector and a switching unit, the switching unit being able to switch between a first position in which the first connector is connected to the first terminal and a second position in which the first connector is connected to the second terminal.

### CROSS REFERENCE TO RELATED APPLICATIONS

The present application is a U.S. National Phase application under 35 U.S.C. § 371 of International Patent Application No. PCT/EP2021/083098 filed Nov. 26, 2021, which claims priority of French Patent Application No. 20 12259 filed Nov. 27, 2020. The entire contents of which are hereby incorporated by reference.

### FIELD OF THE INVENTION

The present invention relates to a device for inerting a battery. The present invention also relates to a power supply unit and a system including such an inerting device. The invention also relates to a corresponding inerting method.

### BACKGROUND

The development of telecommunications involves the use of an increasing number of satellites to transmit information from one point to another on the Earth, in particular telephone communications, data transmission, satellite communications or television programs.

A satellite is a device placed in orbit around a planet, in this case the Earth, by a rocket or a space shuttle. Such a satellite is sometimes referred to as an artificial satellite. Satellites used in the field of telecommunications are usually called “telecommunications satellites” and are generally placed in geostationary orbit.

Satellites are also used for other applications such as Earth observation or geolocation. Such satellites are sometimes called “observation satellites”.

This leads to the existence of fleets of satellites positioned in low orbit.

However, satellites have a limited lifespan (typically about 15 years for geostationary telecommunications satellites), notably due to the exhaustion of propellants that allow a satellite to maintain its orbit on a nominal trajectory and to orient its instruments.

When this lifetime ends (nominally or prematurely due to an incident, for example) and to avoid collisions in space due to its loss of maneuverability, it is desirable to be able to eliminate the satellite that has become obsolete.

A known technique for this is to make such a satellite return to Earth via a well-chosen trajectory, which will burn up while crossing the layers of the atmosphere (another technique being to put it on a so-called “trash” orbit).

However, it is necessary to ensure the safety of this return and in particular to avoid any risk of explosion, in particular during the crossing of the atmosphere. Indeed, to limit the debris evolving around the Earth is desirable since they represent a danger for future launches and objects already launched. This risk exists in particular for the battery which contains flammable products, which is potentially charged (via the still operating solar panels) and which it is advisable to passivate as well as possible.

More generally, such a problem arises for the entire e-waste recovery chain in which it must be ensured that the battery does not run any risk of explosion.

There is therefore a need for a battery inerting device presenting good efficiency and easy implementation to be compatible with the standards of the space domain.

To this end, the description describes a battery inerting device comprising a first terminal and a second terminal, the first terminal and the second terminal presenting opposite polarity, the inerting device comprising a connection circuit, the connection circuit connecting the battery to at least one charging circuit, the connection circuit comprising a first connector, a second connector and a switching unit, the switching unit being able to switch between a first position in which the first connector is connected to the first terminal and a second position in which the first connector is connected to the second terminal.

### SUMMARY

According to particular embodiments, the inerting device presents one or more of the following features, taken alone or in any technically possible combination:
the switching unit is also suitable for connecting the second connector to the second terminal in the first position and for connecting the second connector to the first terminal in the second position.
the switching unit is also able to switch to a third position in which the battery is short-circuited or open-circuited.
the connection circuit is configured to supply the same load circuit.
the switching unit includes at least one two-position contactor.
the switching unit is a set of two two-position contactors.
each contactor is connected to a respective connector.
each contactor is connected to a respective terminal.

The description also describes a power supply unit including a battery and an inerting device for the battery, the inerting device being as previously described.

According to one particular embodiment, the battery is a battery comprising lithium.

The description also relates to a system including a charging circuit and a power supply as previously described.

According to particular embodiments, the system presents one or more of the following features, taken alone or in any technically possible combination:
the charging circuit is a solar panel.
the charging circuit is the control and power distribution circuit.

The present description also proposes a method for inerting a battery comprising a first terminal and a second terminal, the first terminal and the second terminal presenting opposite polarity, the method being implemented by an inerting device comprising a connection circuit, the connection circuit connecting the battery to at least one charging circuit, the connection circuit comprising a first connector, a second connector and a switching unit, the method comprising a switching step between a first position in which the first connector is connected to the first terminal and a second position in which the first connector is connected to the second terminal.

According to particular embodiments, the method presents one or more of the following features, taken alone or in any technically possible combination:
in the first position, the second connector is connected to the second terminal, in the second position, the second connector is connected to the first terminal, and the method includes a step of discharging the battery through the load circuit in the second position.
during the discharge step, the battery is successively in a discharge phase, in an over-discharge phase, in a reversal phase and then in a fully passivated state.

### BRIEF DESCRIPTION OF THE DRAWINGS

Features and advantages of the invention will become apparent from the following description, which is given only as a non-limiting example, and is made with reference to the attached drawings, in which:

FIG. 1 is a schematic view of an example of a satellite comprising an inerting device and a battery,

FIG. 2 is a representation of a graph illustrating the variation of the voltage of a battery as a function of the percentage of depth of discharge of the battery

FIG. 3 is a schematic view of one example of an inerting device in a first position,

FIG. 4 is a schematic view of the inerting device of FIG. 3 in a second position,

FIG. 5 is a schematic view of the inerting device of FIG. 3 in a first intermediate position

FIG. 6 is a schematic view of the inerting device of FIG. 3 in a second intermediate position

FIG. 7 is a schematic view of the inerting device of FIG. 3 in yet a third intermediate position

FIG. 8 is a schematic view of another example of an inerting device in a first position, and

FIG. 9 is a schematic view of yet another example of an inerting device in an alternate intermediate position.

### DETAILED DESCRIPTION

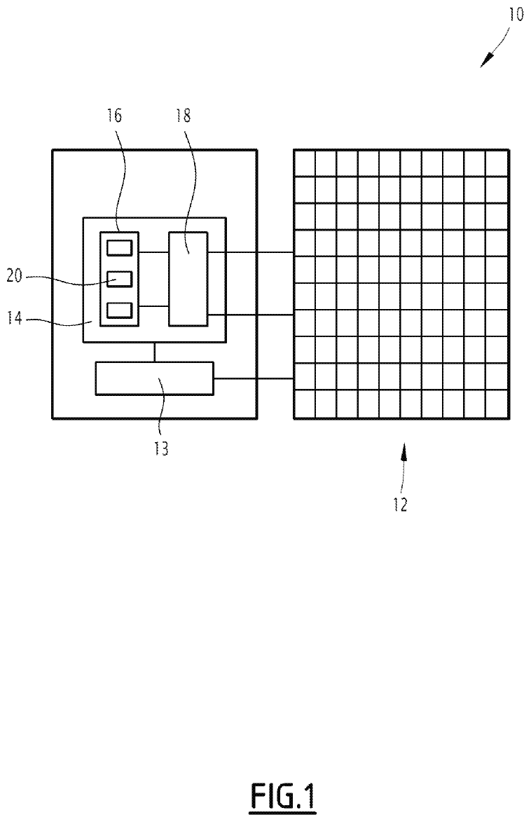

A satellite 10 is shown in FIG. 1.

The satellite 10 comprises a payload which brings together the necessary instruments to perform the mission and a platform that supports the payload and provides the resources which the payload needs for its operation.

Only a portion of the platform is shown in FIG. 1 for simplicity.

The satellite 10 comprises a photovoltaic panel 12, a control and power distribution circuit 13 and a power supply unit 14.

A photovoltaic panel 12 is a device that converts a portion of the solar radiation into electricity.

The photovoltaic panel 12 is connected to the control and power distribution circuit 13.

Such a circuit is more commonly referred to as a PCDU, the abbreviation referring to the English name for “Power and Control Distribution Unit”.

In the following, the control and power distribution circuit 13 is referred to as PCDU 13.

In the case of FIG. 1, the power supply unit 14 includes a battery 16 and an inerting device 18.

The photovoltaic panel 12 and the power supply unit 14 allow power to be provided to the satellite 10 under all circumstances.

More specifically, when the satellite 10 receives sunlight, the photovoltaic panel 12 is able to supply the power supply unit 14 (and thus the battery 16) and the payload of the satellite 10.

When the photovoltaic panel 12 is no longer exposed to light or when the darkness is such that the photovoltaic panel 12 is not sufficient to power the entire satellite, the battery 16 is able to power the satellite 10 by taking over from the photovoltaic panel 12 or by assisting it respectively.

A battery 16 is a generic term for a set of electrochemical accumulators 20, called cells, connected together (in series and/or in parallel) so as to create an electrical generator of desired voltage, power and capacity C.

A battery 16 converts the electrical energy accumulated during the charging phase into chemical energy. The chemical energy is constituted by electrochemically active compounds arranged in the cell. The electrical energy is restored by converting the chemical energy into electrical energy during the discharge phase.

The electrodes, arranged in a container, are electrically connected to current output terminals that ensure electrical continuity between the electrodes and an electrical consumer with which the cell is associated.

According to the “series/parallel” interconnection configuration chosen (single or multiple) of the electrochemical cells, the battery 16 is formed of one or more modules electrically connected in series or in parallel. According to the case, each module is formed of one or more branches electrically connected in series or in parallel where each branch is formed of one or more electrochemical cells electrically connected in series (in the case of “one” electrochemical cell, this one can be unique or be itself the result of several accumulators electrically connected in parallel)

The battery 16 comprises a first terminal 21 and a second terminal 22.

In the described example, the first terminal 21 is a positive terminal and the second terminal 22 is a negative terminal.

According to the described example, the battery 16 is a lithium-ion battery.

In addition, the battery 16 is unique in that the Li-ion electrochemical cells constituting the battery 16 include a negative electrode collector comprising copper.

In the following, the behavior of such a battery 16 in discharge is exploited.

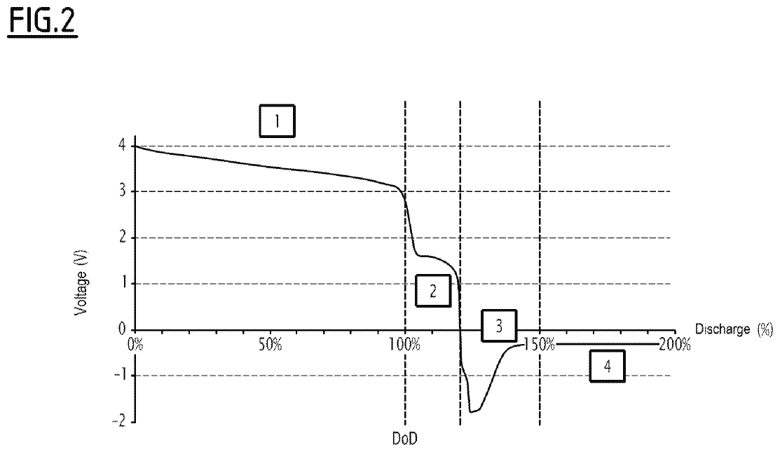

The battery 16 presents the discharge curve shown in FIG. 2. This curve corresponds to a discharge at C/2 at 20° C., bearing in mind that the following remarks are valid for different discharge current values (discharge regime) and different temperatures.

In this curve, four phases are present and are now described.

The first phase corresponds to the classical discharge.

The second phase is an over discharge phase due to the fact that the cathode of the battery 16 has an excess of lithium.

The boundary between the first phase and the second phase is generally referred to as DoD. The term “DoD” refers to “Depth of Discharge”.

The third phase is a reversal phase. The third phase is so called because the voltage of the battery 16 becomes negative and the third phase ends with the forging of the short circuit.

The fourth phase corresponds to a fully passivated state. In the fourth phase, the battery 16 presents a purely resistive behavior as a result of the forging of the internal short circuit by the copper dendrites.

The inerting device 18 is a device for inerting the battery 16.

Inerting consists in eliminating the risk of accidental phenomena (explosion, pollution, etc.) caused by one or more poorly confined reactive products.

In practice, inerting consists of “irreversibly” removing the electrochemical active character of the cells making up the battery 16, in other words, removing its stored energy and its ability to resume charging.

In this case, the inerting device 18 ensures the passivation of the battery 16.

The inerting device 18 includes a connection circuit 24 that comprises a first connector 26, a second connector 28, and a switching unit 30.

The connection circuit 24 connects the battery 16 to the photovoltaic panel 12 (according to the embodiment of FIG. 1).

The first connector 26 and the second connector 28 are the outputs of the connection circuit 30 that are intended to be connected to the photovoltaic panel 12 (according to the embodiment of FIG. 1).

The switching unit 30 comprises a set of two contactors C1 and C2 with two positions.

A contactor is a controlled device able to establish or interrupt the flow of current.

Each contactor C1 and C2 includes one pole and two terminals.

Such a contactor is more often referred to as a SPDT, which literally means “Single Pole Double Throw” (in fact: 1 common pole and 2 other terminals in order to realize 2 electrical contact positions).

In this example, each contactor C1 and C2 is an MBB contactor. The abbreviation “MBB” refers to the English name of “Make Before Break” which literally means “to make before breaking”. In concrete terms, this means that the new connection is made before the old one is broken, thus avoiding situations where the power is not supplied.

In the following, for clarity, the pole of the first contactor C1 is called first pole P1; the terminals of the first contactor C1 are called first terminal T1 and second terminal T2, respectively.

Similarly, the pole of the second contactor C2 is called second pole P2 and the terminals of the second contactor C2 are called third terminal T3 and fourth terminal T4, respectively.

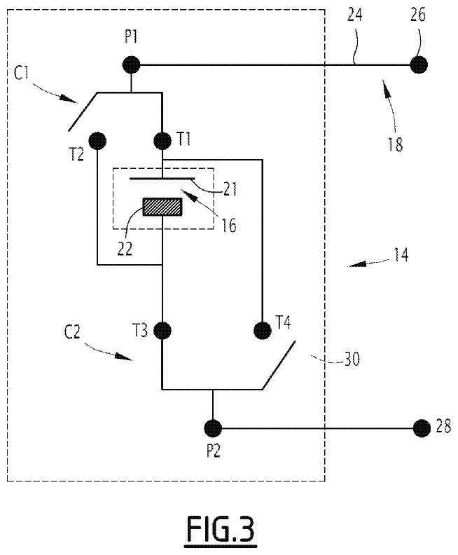

In the described example, the switching unit 30 can take five positions which are respectively visible in FIGS. 3 to 7.

Before describing the specifics of each of the positions, it is worth noting first the elements common to all five positions.

Concerning the first contactor C1, the first pole P1 is connected to the first connector 26 of the connection circuit 24, the first terminal T1 is connected to the positive terminal 21 of the battery 16 and the second terminal T2 is connected to the negative terminal 22 of the battery 16.

For the second contactor C2, the second terminal P2 is connected to the second connector 28 of the connection circuit 24, the third terminal T3 is connected to the negative terminal 22 of the battery 16 and the fourth terminal T4 is connected to the positive terminal 21 of the battery 16.

In the first position corresponding to FIG. 3, the first pole P1 is connected to the first terminal T1.

This implies that the first connector 26 is connected to the positive terminal 21 of the battery 16.

Furthermore, the second pole P2 is connected to the third terminal T3.

This implies that the second connector 28 is connected to the negative terminal 22 of the battery 16.

In such a position, either the battery 16 is supplied by the photovoltaic panel 12, or the battery 16 is able to deliver by discharging the energy stored via the PCDU 13.

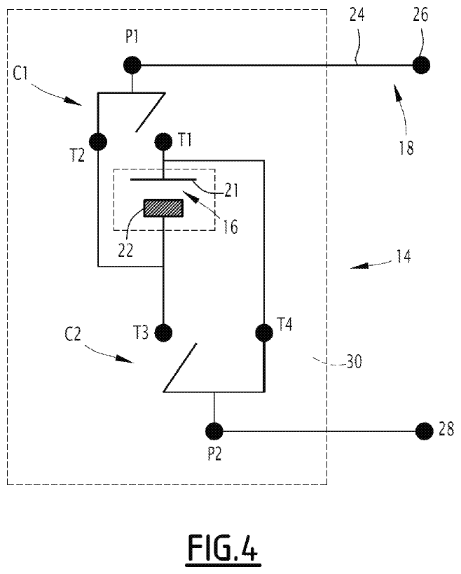

In the second position corresponding to FIG. 4, the first pole P1 is connected to the second terminal T2.

This implies that the first connector 26 is connected to the negative terminal 22 of the battery 16.

Furthermore, the second pole P2 is connected to the fourth terminal T4.

This implies that the second connector 28 is connected to the positive terminal 21 of the battery 16.

In such a position, when the photovoltaic panel 12 is illuminated, the photovoltaic panel delivers a current to the connection circuit 24 which for it, is a charging current, but which in fact leads, with the polarities of the battery 16 reversed, to a forced discharge of the battery 16.

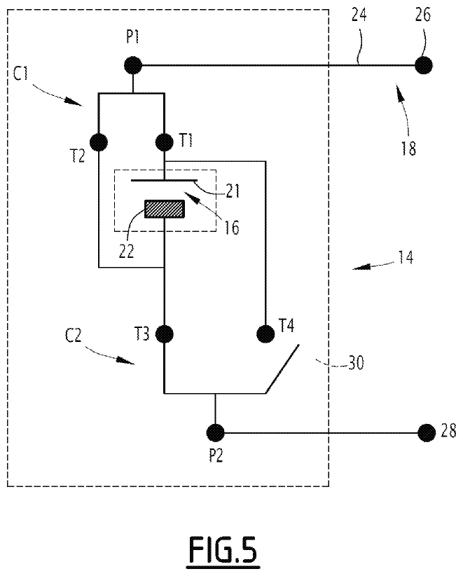

In the third position corresponding to FIG. 5, the first pole P1 is still connected to the first terminal T1 and is just connected to the second terminal T2.

This implies that the first connector 26 is connected to the positive terminal 21 and to the negative terminal 22 of the battery 16.

Furthermore, the second pole P2 is still connected to the third terminal T3.

This implies that the second connector 28 is connected to the negative terminal 22 of the battery 16 and to the first connector 26.

The third position thus corresponds to an intermediate position between the first position and the second position in which the battery 16 is short-circuited and the photovoltaic panel 12 is short-circuited.

The term “intermediate position” refers to the fact that the position is a one-time position and is not intended to last, unlike the first position and the second position.

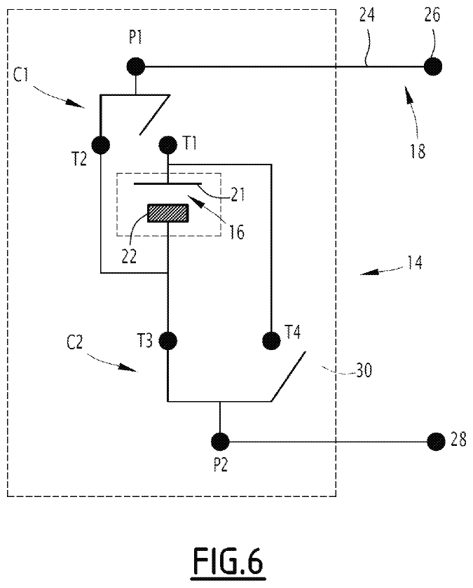

In the fourth position corresponding to FIG. 6, the first pole P1 is connected to the second terminal T2.

This implies that the first connector 26 is connected to the negative terminal 22 of the battery 16.

Furthermore, the second pole P2 is still connected to the third terminal T3.

This implies that the second connector 28 is connected to the negative terminal 22 of the battery 16.

The fourth position thus corresponds to an intermediate position between the first position and the second position in which the battery 16 is in open circuit and the photovoltaic panel 12 is in short circuit.

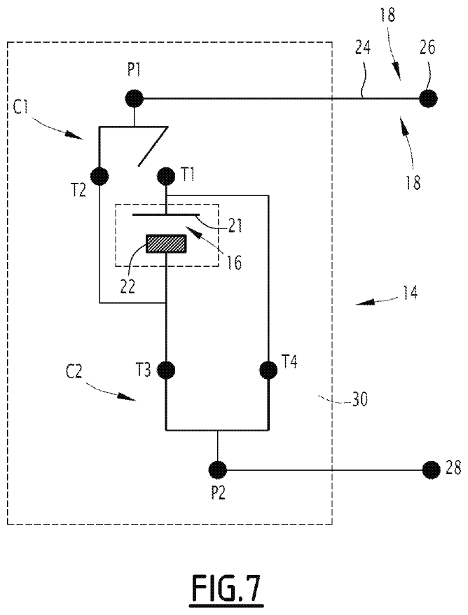

In the fifth position corresponding to FIG. 7, the first pole P1 is connected to the second terminal T2.

This implies that the first connector 26 is connected to the negative terminal 22 of the battery 16.

Furthermore, the second pole P2 is still connected to the third terminal T3 and is just connected to the fourth terminal T4.

This implies that the second connector 28 is connected to the negative terminal 22 and to the positive terminal 21 of the battery 16.

The fifth position thus corresponds to an intermediate position between the first position and the second position in which the battery 16 is short-circuited and the photovoltaic panel 12 is short-circuited.

The switching unit 30 is thus able to switch between several positions, a first position in which the battery 16 is connected in a first direction, a second position in which the battery 16 is connected in a second direction opposite to the first, and a plurality of intermediate positions in which the battery 16 is either short-circuited or open-circuited.

Moving from the first position to the second position thus amounts to a reversal of the terminals 21 and 22 of the battery 16.

The operation of the satellite 10 is now described.

When the satellite 10 is in operation during its rated lifetime, the switching unit 30 is in the first position.

This means that the photovoltaic panel 12 comes to charge the battery 16 when the photovoltaic panel 12 receives solar radiation.

When the photovoltaic panel 12 is no longer sending energy, the battery 16 comes to supply the equipment of the satellite 10 with electricity, in particular, the payload.

This operation lasts as long as the life of the satellite 10 is less than its nominal life.

Once this lifetime is over, the satellite 10 must return to Earth in our example.

To do this, the battery must be inerted and the following inerting process takes place.

The switching unit 30 switches from the first position to the intermediate positions.

In the proposed sequencing example, the switching unit 30 switches successively to the third position, the fourth position and the fifth position.

The battery 16 is thus successively short-circuited, open-circuited and short-circuited while the photovoltaic panel is short-circuited.

The switching of the switching unit 30 is preferably done when the battery 16 is discharged (end of the first phase) or as discharged as possible in order to operate in the shortest possible time (therefore with the objective of inerting in one cycle in the case of using irreversible contactors C1 and C2) during the period when the panel is illuminated and delivers a current (of load with respect to it).

Switching between the intermediate positions is done as quickly as possible to limit the exposure time to short circuits.

Then, the switching unit 30 switches from the fifth position to the second position.

In the second position, the photovoltaic panel 12 delivers current to the battery 16 the polarities of which, have been reversed via its terminals 21 and 22.

The current delivered to the battery 16 is in a direction such that it performs a forced discharge. To avoid thermal runaway of the battery 16, a discharge rate of less than half the capacity (<0.5C) of the battery 16 is chosen, the capacity of a battery being the energy capacity of a battery to deliver a certain current for a certain time.

Preferably, for even better safety, if the value of the current can be changed and if the time to operate the inerting is not critical, the current delivered corresponds to a regime of 0.3C.

This leads the battery 16 to move from the end of the first phase (because it is possible that the battery 16 is not discharged to 100% DoD when the switchover from the first position to the third position takes place) to the second phase, then from the second phase to the third phase, and then from the third phase to the fourth phase on the curve shown in FIG. 2.

In the fourth phase, the battery 16 loses its electrochemical or active character. The battery 16 behaves electrically like a resistor.

The battery 16 is thus completely passivated in several respects: all of the accumulators 20 are passivated and not just a part of them, and the passivation is irreversible, which means in particular that it is not possible for the battery 16 to return to a charged state.

The inerting device 18 thus performs a passivation process of a battery 16 by inversion of its terminals 21 and 22 with respect to the charging circuit 12.

This makes it possible to obtain an inerting method that is easy to implement.

Indeed, no modification of the position of the satellite 10 or rotation of the solar panel 12 is required.

The inerting method only involves the use of a switching unit 30.

In addition, the inerting device 18 operates in a safe manner in that electrical continuity is maintained and the pressure and temperature conditions remain under control at all times so that each accumulator 20 remains in “nominal below limit” operating conditions (no leakage, no circuit breaker operation).

The inerting device 18 also allows inerting to be achieved in a relatively short time. For example, it is possible to obtain inerting in less than 23 hours, which is compatible with the requirements of the space domain in geostationary orbit at a current regime of C/10.

In addition, the inerting device 18 is adaptable to the electrical characteristics of the battery 16, in particular its voltage and capacity.

Other embodiments of the inerting device 18 are conceivable.

For example, according to another embodiment, the sequencing mode is different since the switchover consists in switching the second contactor C2 first instead of the first contactor C1.

The intermediate positions of FIGS. 5 to 7 are then different.

In the third modified position, the first pole P1 is still connected to the first terminal T1.

This implies that the first connector 26 is connected to the positive terminal 21 of the battery 16.

Furthermore, the second pole P2 is still connected to the third terminal T3 and is just connected to the fourth terminal T4.

This implies that the second connector 28 is connected to the negative terminal 22 and to the positive terminal 21 of the battery 16.

In the fourth modified position, the first pole P1 is still connected to the first terminal T1.

This implies that the first connector 26 is connected to the positive terminal 21 of the battery 16.

Furthermore, the second pole P2 is connected to the fourth terminal T4.

This implies that the second connector 28 is connected to the positive terminal 21 of the battery 16.

In the fifth modified position, the first pole P1 is still connected to the first terminal T1 and is just connected to the second terminal T2.

This implies that the first connector 26 is connected to the positive terminal 21 and the negative terminal 22 of the battery 16.

Furthermore, the second pole P2 is connected to the fourth terminal T4.

This implies that the second connector 28 is connected to the positive terminal 21 of the battery 16.

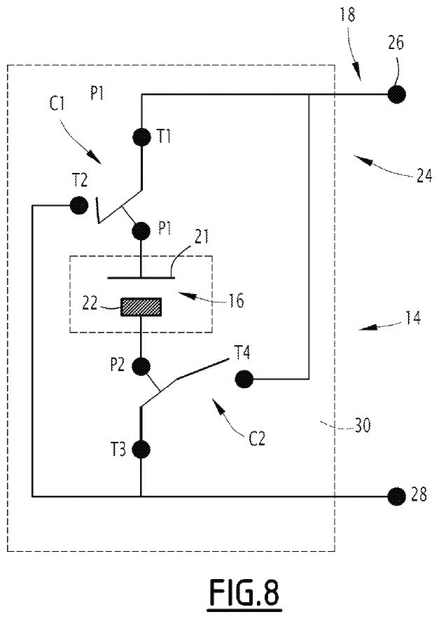

According to another embodiment corresponding to FIG. 8, the switching unit 30 presents a connection of the contactors C1 and C2 that differs from that of FIGS. 3 to 7.

In this configuration, the first pole P1 is connected to the positive terminal 21 of the battery 16, the second pole P2 is connected to the negative terminal 22 of the battery 16, the first terminal T1 and the fourth terminal T4 are connected to the first connector 26 and the second terminal T2 and the third terminal T3 are connected to the second connector 28.

According to another alternative or additionally, the switching unit 30 includes other switches, such as a rotator, a relay or even a contactor with one pole and one terminal. Such a switch is more often referred to as a SPST, which stands for “Single Pole Simple Throw”. In the latter case, SPST contactors make a single respective contact between a pole and a terminal.

According to the present case, either reversible or irreversible contactors can be used. The choice between these types of contactors can be guided by various considerations such as the need for reliability (fear of an untimely command, of an untimely triggering), the need to proceed in several cycles to obtain a depth of discharge guaranteeing the inert state and the possibility of passing or not through short-circuit phases.

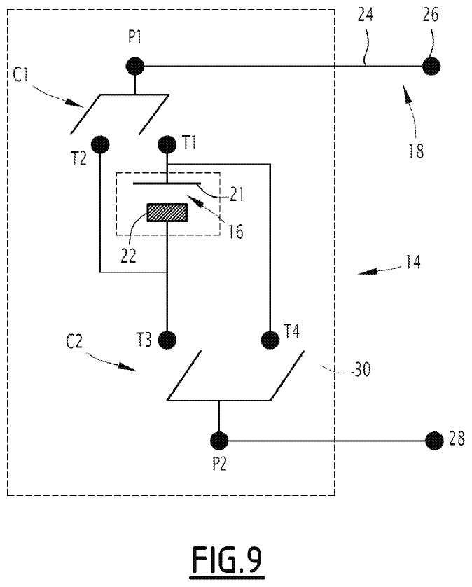

Alternatively, BBM type contactors are used. The abbreviation “BBM” refers to the English term “Break Before Make”, which literally means “break before making”. Such an alternative is particularly advantageous in the case where the payload is supplied by the illuminated photovoltaic panel 12 during the inerting procedure. Indeed, the switching sequence between the first position and the second position is less constrained since there would no longer be any need to guarantee the continuity of the supply of the payload by the battery and therefore would allow to no longer pass through the intermediate phases of punctual short-circuit between the battery 16 and the photovoltaic panel 12. The switching unit 30 can then operate using the position shown in FIG. 9 as an intermediate position.

In the position shown in FIG. 9, the first pole P1 is no longer connected to the first terminal T1.

This implies that the first connector 26 is no longer connected to the positive terminal 21 of the battery 16.

Furthermore, the second pole P2 is no longer connected to the third terminal T3.

This implies that the second connector 28 is no longer connected to the negative terminal 22 of the battery 16.

The position in FIG. 9 thus corresponds to an intermediate position between the first position and the second position in which the battery 16 is in open circuit and the photovoltaic panel 12 is in open circuit (but in closed circuit with the payload).

The inerting device 18 can also be used in other contexts.

Thus, according to one example, the charging circuit 12 is a PCDU 13.

In general, the inerting device 18 can operate with any charging circuit 12 able to operate with both polarities of the battery 16.

In some applications, it may be contemplated to use multiple charging circuits 12.

Furthermore, for the example described, the system 10 is a satellite but any other system is conceivable.

By way of illustration, the system 10 could be a waste recovery system.

In such a case, the inerting device 18 prevents any risk of explosion of the battery 16.

In addition, the inerting device 18 is capable of ensuring the inerting of any type of battery presenting a behavior similar to that described in FIG. 2 for the battery 16 (namely what is similar to an “internal electrolysis of the accumulators 20” leading to a metal deposit and a short-circuiting by a simple “forced reversal”).

In particular, it should be noted that many materials are possible for the battery 16.

As a reminder, an electrochemical cell, still referred to as a “cell” in the following, comprises an electrochemical bundle constituted of alternating cathodes and anodes framing a separator impregnated with electrolyte. Each cathode and anode is constituted of a metal current collector supporting on at least one of its faces at least one active material and generally a binder and an electronically conductive material such as carbon.

Thus, the active material of the cathode can vary according to the case considered.

In particular, according to a first example, the active material is a compound of formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2.

According to a particular case, the active material has the formula LiMn_{1-y}Fe_{y}PO₄, and advantageously LiMnPO₄.

According to a second example, the active material is a compound of the formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb, and Mo, with 0.8≤x≤1.2; 0≤y≤0.6; 0≤z≤0.2.

According to a particular case of the second example, the active material compound has the formula LiₓM_{2-x-y-z-w}M′_{y}M″_{z}M′″_{W}O₂, where 1≤x≤1.15; M denotes Ni; M′ denotes Mn; M″ denotes Co and M′″ is selected from the group consisting of B, Mg, Al, Si, Ca, Ti, V, Cr, Fe, Cu, Zn, Y, Zr, Nb, Mo, Sr, Ce, Ga and Ta or a mixture thereof; 2-x-y-z-w>0; y>0; z>0; w≥0.

According to another particular case, the compound has the formula LiNi1/3Mn1/3Co1/3O₂.

According to yet another particular case, the compound has the formula LiₓM_{2-x-y-z-W}M′_{y}M″_{z}M′″_{w}O₂, where 1≤x≤1.15; M denotes Ni; M′ denotes Co; M″ denotes Al and M′″ is selected from the group consisting of B, Mg, Si, Ca, Ti, V, Cr, Fe, Cu, Zn, Y, Zr, Nb, Mo, Sr, Ce, Ga and Ta or a mixture thereof; 2-x-y-z-w>0; y>0; z≥0; w≥0. Preferably, x=1; 0.6≤2-x-y-z≤0.85; 0.10≤y≤0.25; 0.05≤z≤0.15 and w=0.

Another particular case corresponds to the case where the compound is selected from LiNiO₂, LiCoO₂, LiMnO₂, Ni, Co and Mn which may be substituted with one or more of the elements selected from the group comprising of Mg, Mn (except for LiMnO₂), Al, B, Ti, V, Si, Cr, Fe, Cu, Zn, Zr.

According to a third example, the active material is a compound of the formula LixMn_{2-y-z}M′_{y}M″_{z}O₄ (LMO), where M′ and M″ are selected from the group consisting of B, Mg, Al, Si, Ca, Ti, V, Cr, Fe, Co, Ni, Cu, Zn, Y, Zr, Nb and Mo; M′ and M″ being different from each other, and 1≤x≤1.4;0≤y≤0.6≤0≤0.2.

According to a particular case, the active material has the formula LiMn₂O₄. Another example compound has the formula LiₓMn_{2-y-z}Ni_{y}M″_{z}O₄(LMO), where M″ is selected from the group consisting of B, Mg, Al, Si, Ca, Ti, V, Cr, Fe, Co, Cu, Zn, Y, Zr, Nb and Mo; and 1≤x≤1.4; 0≤y≤0.6; 0≤z≤0.2. An example of this compound is LiMn_{2-y}Ni_{y}O₄ where 0≤y≤0.6, such as LiMn_{1.5}Ni_{0.5}O₄.

According to a fourth example, the active material is a compound of the formula LixFe_{1-y}M_{y}PO₄, where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6.

In a particular embodiment of the fourth example, the active material compound has the formula LiFePO₄.

According to a fifth example, the active material is a compound of the formula xLi₂MnO₃; (1−x)LiMO₂ where M is selected from Ni, Co and Mn and x≤1.

In a particular case of this example, the compound of the active material is Li₂MnO₃.

According to a sixth example, the active material is a compound that is a lithium vanadium fluorophosphate of the formula Li₁₊ₓVPO₄F_{z} where 0≤x≤0.15, or a derivative thereof of the formula Li₁₊ₓV_{1-y}M_{y}PO₄F_{z} where 0≤x≤0.15, 0<y≤0.5, 0.8≤z≤1.2 and M is selected from the group consisting of Ti, Al, Y, Cr, Cu, Mg, Mn, Fe, Co, Ni, and Zr.

Examples of preferred derivatives are LiYₓV₁₋ₓPO₄F (0<x≤0.5), LiCrₓV₁₋ₓPO₄F (0<x≤0.5), LiCoₓV₁₋ₓPO₄F (0<x≤0.5), LiMnₓV₁₋ₓPO₄F (0<x≤0.5), LiTiₓV₁₋ₓPO₄F (0<x≤0.5), LiFeₓV₁₋ₓPO₄F (0<x≤0.5).

According to a seventh example, the active material is a mixture of two or more of the above compounds.

The anodic active material may also vary according to the case under consideration.

Thus, the anodic active material is a material capable of inserting lithium into its structure. The anode active material can be selected from lithium compounds, carbon materials such as graphite, coke, carbon black and glassy carbon. The anode active material may also be tin-based, silicon-based, carbon and silicon-based compounds, carbon and tin-based compounds or carbon, tin and silicon-based compounds. The anode active material may also be lithium metal or lithium alloy based. The anode active material can also be a lithium titanium oxide such as Li₄Ti₅O₁₂ or a niobium titanium oxide such as TiNb₂O₇.

Similarly, the binder may also vary according to the embodiment chosen.

Thus, the binder may be selected from the following compounds, taken alone or in mixture: polyvinylidene fluoride (PVDF) and its copolymers, polytetrafluoroethylene (PTFE) and its copolymers, polyacrylonitrile (PAN), poly(methyl)- or (butyl)methacrylate, polyvinyl chloride (PVC), poly(vinyl formal), a polyester, block polyetheramines, acrylic acid polymers, methacrylic acid, an acrylamide, itaconic acid, sulfonic acid, elastomers and cellulosic compounds.

The same applies to the electronically conductive material which is generally selected from graphite, carbon black, acetylene black, soot, graphene, carbon nanotubes or a mixture thereof. It is typically used at 7% or less relative to the sum of the masses of the anode active material mixture, the binder and the electronically conductive material.

Finally, the separator material may be selected from the following materials: a polyolefin, for example, polypropylene PP, polyethylene PE, a polyester, polymer-bonded glass fibers, polyimide, polyamide, polyaramid, polyamide-imide and cellulose.

The foregoing embodiments may be combined to form further embodiments.

In each of these embodiments, the inerting device 18 comprises the connection circuit 24, the connection circuit 24 connecting the battery 16 to the charging circuit 12, the connection circuit 24 comprising the first connector 26, the second connector 28, and the switching unit 30, the switching unit 30 being able to switch between a first position in which the first connector 26 is connected to one of the terminals 21 or 22 of the battery 16 and a second position in which the first connector 26 is connected to the other of the terminals 21 or 22 of the battery 16.

1. An inerting device for a battery comprising a first terminal and a second terminal, the first terminal and the second terminal presenting opposite polarity, the inerting device comprising a connection circuit, the connection circuit connecting the battery to at least one charging circuit the connection circuit comprising a first connector, a second connector and a switching unit, the switching unit being able to switch between a first position in which the first connector is connected to the first terminal and a second position in which the first connector is connected to the second terminal.

2. The inerting device according to claim 1, wherein the switching unit is also able to connect the second connector to the second terminal in the first position and to connect the second connector to the first terminal in the second position.

3. The inerting device according to claim 1, wherein the switching unit is also able to switch to a third position in which the battery is in short circuit or open circuit.

4. The inerting device according to claim 1, wherein the connection circuit is configured to supply the same charging circuit.

5. The inerting device according to claim 1, wherein the switching unit includes at least one two-position contactor.

6. The inerting device according to claim 1, wherein the switching unit is a set of two two-position contactors.

7. The inerting device according to claim 6, wherein each contactor is connected to a respective connector.

8. The inerting device according to claim 6, wherein each contactor is connected to a respective terminal.

9. A power supply unit including a battery and an inerting device for the battery, the inerting device is according to claim 1.

10. The power supply unit according to claim 9, wherein the battery is a battery comprising lithium.

11. A system including a charging circuit and a power supply according to claim 9.

12. The system according to claim 9, wherein the charging circuit is a solar panel or the control and power distribution circuit.

13. A method for inerting a battery comprising a first terminal and a second terminal, the first terminal and the second terminal having opposite polarity, the method being implemented by an inerting device comprising a connection circuit, the connection circuit connecting the battery to at least one charging circuit the connection circuit comprising a first connector, a second connector and a switching unit, the method comprising a step of switching between a first position in which the first connector is connected to the first terminal and a second position in which the first connector is connected to the second terminal.

14. The inerting method according to claim 13, wherein, in the first position the second connector is connected to the second terminal, in the second position, the second connector is connected to the first terminal, and the method includes a step of discharging the battery through the charging circuit in the second position.

15. The inerting method according to claim 14, wherein during the discharge step, the battery is successively in a discharge phase, in an over discharge phase, in a reversal phase and then in a fully passivated state.
